(19) United States
(12) Patent Application Publication
(10) Pub. No.: US 2002/0177370 A1
(43) Pub. Date: Nov. 28, 2002

(54) Electrical interconnect assembly

(76) Inventor: Russell Mistretta Abbott, Riverside, CA (US)

Correspondence Address: Chris Papageorge, 14625 S. Vermont #5, Gardena, CA, 90247, US

(21) Appl. No.: 09/864,769

(22) Filed: May 25, 2001

(51) Int. Cl. H01R 13/625

(52) U.S. Cl. 439/700

(57) ABSTRACT

The assembly includes an electrically conductive interconnect and a housing attached to a pair of circuit boards or other type of electrical conductor structures. The interconnect is slidably positioned in a hole in the housing and protrudes from opposite ends of the hole in order to make electrical contact with termini of circuit board traces or other types of electrical conductors. The interconnect includes a pin which is partially inserted in a bore in the main body of the interconnect. The pin is biased against the main body to provide it with a desired degree of linear movement relative thereto and in a longitudinal direction relative thereto to ensure that it makes satisfactory contact with the termini so that the interconnect provides the desired electrical interconnection between the boards.

### BACKGROUND OF THE INVENTION

The invention relates generally to structures for providing an electrical interconnection between electrical and electronic elements and systems and, more particularly, to such stuctures which provide a direct electrical interconnection between the electrical traces of printed circuit boards such as computer sound cards, mother boards and the like.

The increasing complexity of computer systems in commercial and personal use and their ever increasing speed and capabilities has motivated many computer users to add, upgrade or substitute video and sound cards and the like in order to take advantage of such improved computer speed and capabilities. However, removing and especially installing such circuit boards in computers is frequently a daunting task even for experienced computer technicians. The task involves the risk of damage to the boards as well as improper or incomplete electrical connection between the boards. In addition, the microelectronic elements that some boards contain may be delicate so that improper handling of the circuit boards nay damage such elements. Conventional board connectors are typically designed so that there is a tight fit between the boards and connectors when they are interconnected. However, due to imprecise manufacturing tolerances of the boards and their interconnection structures, the fit is often excessively tight causing the installer to exert a high degree of force on the boards when attempting to push one onto another to make the desired electrical interconnection therebetween. In addition, an even higher degree of excessive force may be exerted thereon as a result of the installer's frustration in failing to make the proper connection. Such excessive force can easily result in cracking of the board resulting in dysfunction of the board rendering it useless. Moreover, such force can produce very fine hairline cracks in the board which can result in intermittent malfunction of the entire system. With such intermittent malfunctions, it can be very hard and time consuming to diagnose and track down the exact source of the difficulty. The user of the system may thus have to endure prolonged annoyance as well as prolonged damage to the business or personal matter in which the computer system is used and/or high repair costs.

Oftentimes, the tight fit can result in the installer twisting the board or pushing or pulling the sides of the board in an attempt to properly position the board in the recess provided for the edge connection. This can produce bending, rubbing away or dislocation of the surfaces of the circuit termini of the boards resulting in no connection at certain points or crossconnection at certain points.

Frequently, the board may be inadvertently tilted when the installer is attempting to push it into position. When in such a tilted orientation the high force of pushing it into position may bend, squish or otherwise damage the electrical contacts of the boards. Due to the exceedingly small size of these contacts and their proximity to each other, it may not be possible or practical to straighten out or otherwise repair them.

Some types of circuit board interconnection methods use pins at an edge of one board which mate with sockets on the other board. The sockets may be flared at their openings to help direct the pins thereinto and compensate for misalignment between the pins and the sockets. However, this flaring can only compensate for a small degree of misalignment. If the pins are bent out of the range of compensable misalignment, attempted installation of the board onto the interconnection structure will commonly result in bending the pins further out of alignment and possibly breakage of the pins or other type of damage to the pins and/or sockets. As with the other conventional types of interconnection methods, the small size of the pins may render it impossible or impractical to straighten out the pins or otherwise repair the damage to the pins or the receptacles. Consequently, such damage done to such conventional interconnection structures may render what may be an expensive board irreparable, useless and worthless.

Some prior art interconnectors for circuit boards provide an electrical interconnection without requiring a tight fit between the boards and connectors. An example of such a connector assembly is shown in U.S. Pat. No. 6,109,927 to Scholz. The Scholz assembly has a connector contact which is fixedly attached to the connector and placed in a cavity thereof. The contact includes spring arms which deflect outwardly from each other and make contact, with circuit termini. However a primary disadvantage of the Scholz assembly is that it uses a fastener to fixedly attach the connector to the ciruit boards and this makes the connection more difficult and time consuming to make and may result in high stresses being placed on the circuit boards. In addition, the Scholz design is only applicable to circuit boards that are mounted edge to edge and oriented so that they are coplanar so that its applicability is consequently limited.

Other prior art board connectors are designed to allow various types of boards to be interconnected. An example of such a connector is disclosed in U.S. Pat. No. 6,165,025 to Meng. The Meng connector is designed as an edge connector for electrically interfacing a computer daughterboard with a computer motherboard. The Meng assembly is specifically designed for PCI boards and has a switch key which identifies the type of daughterboard and directs the required operational voltage thereto. The Meng assembly is particularly adapted for boards which are oriented so that they are perpendicular to each other. In addition, the Meng assembly uses pin and socket connectors for the boards which may require very high force in installation and removal of boards from such a connector assembly. Thus, the Meng design does not alleviate the risk of damage to the boards due to installation and removal from such connectors.

An improved interconnection means is thus needed that can provide a proper electrical interconnection between conductors without necessitating a high degree of force in electrically connecting and disconnecting the conductors to and from each other to minimize the likelihood of improper electrical connection as well as the likelihood of damage to the conductors and structures associated therewith. What is also needed is such an interconnection means that can be used through many cycles of electrical connection and disconnection while still maintaining the desired firm and positive electrical interconnection.

### SUMMARY OF THE INVENTION

It is a principal object of the present invention to provide an interconnect assembly that can provide a positive electrical connection between two or more electrical conductors using minimal engagement force.

It is an object of the present invention to provide an interconnect assembly that can provide a positive electrical connection between two conductors that are oriented relative to each other so as to form an acute angle between the conductors' substrates.

It is an object of the present invention to provide an interconnect assembly that can provide a positive electrical connection between two conductors that are oriented so that their substrates are perpendicular to each other.

It is an object of the present invention to provide an interconnect assembly that can provide a positive electrical connection between two conductors that are positioned end to end and oriented so that their substrates are in alignment with each other.

It is an object of the present invention to provide an interconnection between conductors mounted on substrates that does not require a socket connector.

It is an object of the present invention to provide an interconnect assembly that can provide a positive electrical connection between two conductors after repeated cycles of engagement and disengagement of the conductors with the assembly.

It is an object of the present invention to provide an interconnect assembly that can provide a positive electrical connection between two conductors within a range of separation distances between the two.

It is also an object of the present invention to provide an interconnect assembly that can withstand the stresses and forces of attempted engagement when the conductors are misaligned.

It is an object of the present invention to provide an interconnect assembly that does not require a precise fit between the electrical conductors and the assembly.

It is an object of the present invention to provide an interconnect assembly that does not require a tight fit between the electrical conductors and the assembly in order to maintain a proper electrical connection therebetween.

It is another object of the present invention to provide an interconnect assembly that allows fast and easy connection of electrical conductors thereto.

It is another object of the present invention to provide an interconnect assembly that allows electrical conductors to be connected thereto without undue risk of damage to thereto.

Essentially, the interconnect assembly of the present invention facilitates the connection and disconnection of electrical conductors to and from each other. Since circuit boards and other types of structures having electrical conductors commonly are designed for electrical connection to other circuit boards and other electronic subsystems and for interchangeability or replacement within the system, the ability to quickly and easily plug such circuit boards and electronic components into the system and remove them therefrom is very desirable. However, since it is also required that such components make a firm and positive electrical connection to the system, conventional thinking has been that tight connections ensure such firm and positive electrical connections and thereby ensure that the system functions properly as a result. Conventional thinking has also been that if the electrical connections are not tight the connections will quickly loosen up to the point that the connections will no longer make positive electrical contact. Thus, prior art methods have the circuit termini located at the large planar outer surfaces of the boards making the mechanical and electrical direct connection with the circuit board connector, and this includes a tight fit therebetween. But, such tight connections tend to make the connection and disconnection process more time consuming as well as increase the likelihood that damage to the microelectronic elements or other system components at the site of the connections will eventually ensue due to the often excessive degree of force needed to make the connection and disconnection. But, the assembly of the present invention obviates these shortcomings by providing an interconnection without a tight fit between the conductor structures. The assembly of the invention electrically connects the conductors together via the circuit termini located at the relatively narrow edge faces of one or both of the circuit boards, and this does not utilize a tight fit between the boards and the assembly. Indeed, the boards may even be somewhat loosely fitted to the assembly yet still have a firm and positive electrical connection therebetween. Thus, there is low insertion force involved in installing the board in the assembly. Providing the desired interconnection without a tight fit also eliminates the high force otherwise required for connection and disconnection thereby minimizing the likelihood that damage to the electrical conductors or structures associated therewith will result from connection and disconnection of the conductors. The unique structures of the present invention instead enable both quick and easy connection and disconnection and additionally provide a firm and positive electrical connection. The unique structures of the invention also enable the connection and disconnection to be made without undue force being exerted thereon resulting in minimal stress being placed on the electrical conductors and their associated structures thereby minimizing the likelihood that they will be bent, cracked or otherwise damaged from the process of connection and/or disconnection. Moreover, since the conductors and associated structures are not subjected to undue stress, there is very little wear and tear that results from the process of connection and disconnection. Since there is very little pressure exerted on the conductors or their associated structures and also very little wear and tear thereon that would otherwise produce undesirable structural changes thereto, these very desirable attributes persist even after repeated cycles of connection and disconnection.

The assembly of the invention also includes a housing to which the electrical conductors are attached. The electrical conductors may, for example, be in the form of traces on a computer card which are to be connected to a computer motherboard. The computer card may have an edge connector structure which is insertable in the housing yet manually withdrawn therefrom. The housing is permanently and securely attached to the motherboard but, in one embodiment, is permanently and securely attached to the daughterboard. Since there is minimal force required for the attachment and detachment of the board to and from the housing, the housing may be positioned at any desired location on the motherboard since there is no need to ensure that the motherboard location can withstand the stresses and strains of attachment and detachment as would be required with prior art designs. Moreover, the housing may be structured so that the computer card can be oriented at any desired angle relative to the motherboard instead of just the conventional orientation of perpendicular to the motherboard. This is particularly advantageous in computer system designs where space is limited or access to the computer components is limited.

The assembly accomplishes these by using an interconnect structure which is linearly movable in a housing to provide a positive electrical interconnection between electrical conductors. The housing has an aperture which is open at opposite ends and in which the interconnect is positioned and dimensioned so that it protrudes therefrom. The interconnect includes a pin which is mounted within a bore in the main body of the interconnect yet protrudes from an end thereof. Thus, this enables the pin to extend outwardly from one end of the aperture and the other end of the interconnect main body to extend from the other end of the aperture. This results in the interconnect making a firm and positive electrical contact at both of its opposite ends with electrical conductors which are mounted in or on the housing and positioned so that they are in physical contact with both opposite ends of the interconnect.

The pin is electrically connected to the interconnect main body and the interconnect is composed of an electrically conducting material. The interconnect is thus an electrically conducting structure and therefore able to conduct an electrical current therethrough. When the electrical conductors are positioned against and in contact with the interconnect it provides an electrical interconnection therebetween.

Since circuit board edge portions as well as many other types of electrical conductor structures may not be made with a high degree of precision resulting in the components perfectly fitting together via their interconnectors, the assembly of the present invention has unique structures which allow it to compensate for such imprecision when the conductors are connected together. Thus, board to board variations in the thickness thereof do not compromise the invention's ability to provide a firm and positive electrical interconnection between the boards. The interconnect accomplishes this by slidably mounting the pin within the bore in the main body of the interconnect and biasing the pin against the main body. The slidable feature in combination with the biasing of the pin enable the interconnect to make the desired electrical contact within an entire range of separation distances between the conductors when the conductors are mounted in or on the housing. Thus, even components which would otherwise poorly fit together may be electrically interconnected with the unique assembly of the present invention. In addition, biasing of the pin and slidably mounting of the interconnect main body in the housing provides a combination of structures that can perform their desired interconnection function without undue stresses and strains thereon so that there is no appreciable wear and distortion of the structures resulting from connection and disconnection. This enables the interconnect assembly to be used for many cycles of connection and disconnection without any adverse affect on the electrical connection provided. This feature is particularly advantageous in computer systems which may require substitution or upgrade of video cards, peripherals, etc.

### BRIEF DESCRIPTION OF THE DRAWINGS

FIG. 1 is a perspective view of a first embodiment of the electrical interconnection assembly of the present invention shown interconnecting a motherboard and a daughterboard showing the boards oriented so that they are perpendicular to each other and showing the assembly detachably connected to the daughterboard.

FIG. 2 is a cross-sectional view of the interconnection assembly of the first embodiment also showing the two circuit boards thereof and taken along lines 2-2 of FIG. 1.

FIG. 3 is an exploded view of the assembly of the first embodiment also showing the two boards thereof.

FIG. 4 is a top view of the assembly of the first embodiment.

FIG. 5a is a side view of the interconnect of the assembly of the first embodiment of FIG. 1.

FIG. 5b is a side longitudinal sectional view of the interconnect of the assembly of the first embodiment.

FIG. 6 is a perspective view of a second embodiment of the electrical interconnection assembly of the present invention shown interconnecting a motherboard and a daughterboard showing the boards oriented so that they are perpendicular to each other and showing the assembly detachably connected to the motherboard.

FIG. 7 is a cross-sectional view of the interconnection assembly of the second embodiment also showing the two circuit boards thereof and taken along lines 7-7 of FIG. 6.

FIG. 8 is an exploded view of the assembly of the second embodiment also showing the two boards thereof.

FIG. 9 is a top view of the assembly of the second embodiment.

FIG. 10a is a side view of the interconnect of the assembly of the second embodiment.

FIG. 10b is a side longitudinal sectional view of the interconnect of the assembly of the second embodiment.

FIG. 11 is a perspective view of a third embodiment of the interconnection assembly of the present invention shown interconnecting two circuit boards at end portions thereof so that the boards are in mutual alignment.

FIG. 12 is a cross-sectional view of the interconnection assembly of the third embodiment also showing the two circuit boards thereof and taken along lines 12-12 of FIG. 11.

FIG. 13 is an exploded view of the assembly of the third embodiment also showing the two boards thereof.

FIG. 14 is a top view of the assembly of the third embodiment.

FIG. 15a is a side view of the interconnect of the assembly of the third embodiment.

FIG. 15b is a side longitudinal sectional view of the interconnect of the third embodiment.

FIG. 16 is a perspective view of a fourth embodiment of the interconnection assembly of the present invention shown interconnecting two circuit boards showing the boards oriented so that they form an acute angle with each other.

FIG. 17 is a cross-sectional view of the interconnection assembly of the fourth embodiment also showing the two circuit boards thereof.

FIG. 18 is an exploded view of the assembly of the fourth embodiment also showing the boards thereof.

FIG. 19 is a top view of the assembly of the fourth embodiment.

FIG. 20a is a side view of the interconnect of the assembly of the fourth embodiment.

FIG. 20b is a side longitudinal sectional view of the interconnect of the assembly of the fourth embodiment.

### DETAILED DESCRIPTION OF THE PREFERRED EMBODIMENTS

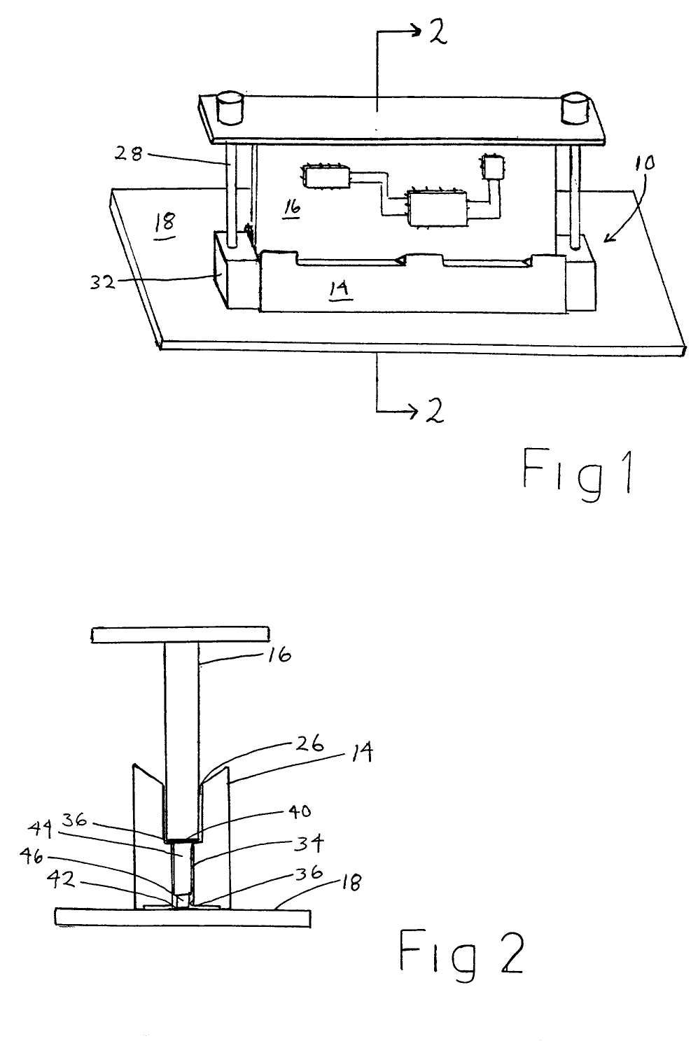

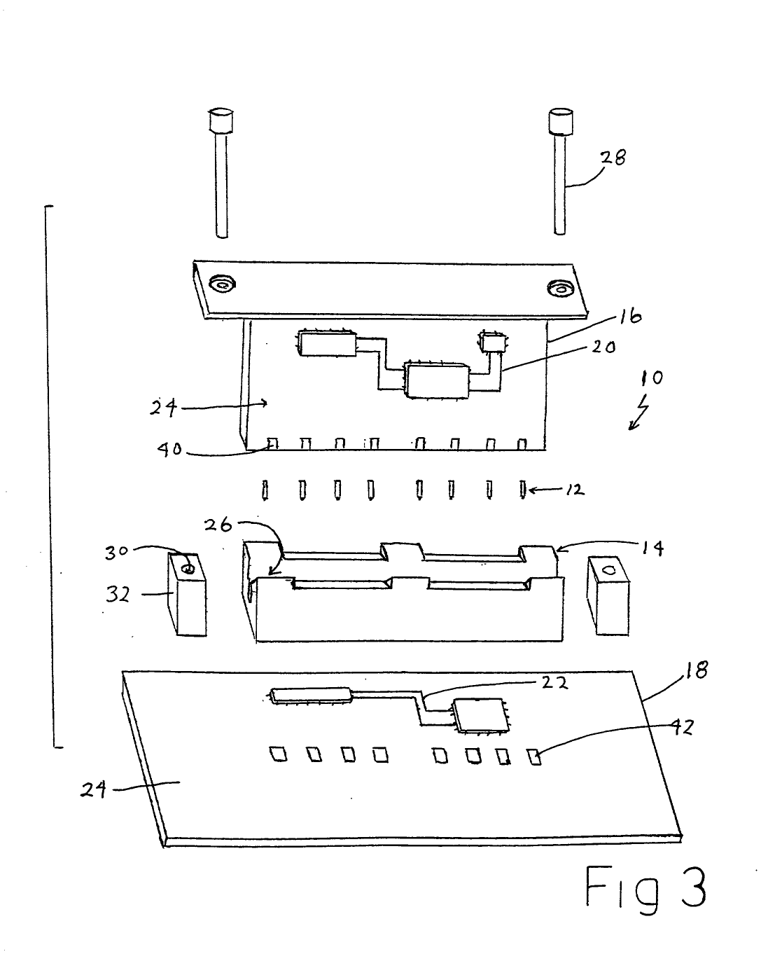

Referring now to the drawings, the first embodiment of the invention is generally designated by the numeral 10. The assembly 10 includes an interconnect 12 mounted in a housing 14. In an exemplary application, FIGS. 1 and 2 show the assembly 10 with a daughterboard or computer card 16 and a computer motherboard 18 attached thereto. The boards 16 and 18 are conventional circuit boards having electrical conductors in the form of traces 20 and 22 and having microelectronic devices mounted on a substrate 24. However, the assembly 10 of the invention may also be utilized to interconnect other types of circuit boards as well as other types of electronic or electrical components. The computer card 16 is inserted into a recess 26 for physical connection to the housing 14 which is preferably elongate to accomodate the typical shape of such circuit boards. A guide 28 is preferably also included for insertion into a corresponding hole 30 in a guide block 32 which is attached to the housing 14 at sides thereof for guiding the card 16 into the housing 14 to ensure that the card 16 is properly positioned in the housing 14. The card 16 may be manually withdrawn from the housing 14. Optionally, a latch structure or retainer structure (not shown) may be provided to retain the card 16 in the desired position in the assembly housing 14.

The housing 14 is preferably securely attached to the motherboard 18. As shown in FIGS. 1 and 2, the housing is attached to the motherboard 18 and the recess 20 is structured so that the card 16 is normal to the motherboard 18. The card 16 and motherboard 18 are preferably both conventional planar circuit boards. The card 16 thus may be manually connected and disconnected to and from the housing 14 whereas the motherboard is fixed to the housing 14.

FIG. 2 shows an aperture 34 which is vertically oriented so that it extemds in the direction of the motherboard 18 when the housing 14 is attached thereto. The aperture 34 receives the interconnect 12 therein. The aperture 34 is preferably circular in cross-section, and the interconnect 12 is also preferably circular in cross-section. The aperture 34 and the interconnect 12 are preferably laterally dimensioned so that there is a snug fit between the interconnect 12 and the aperture 34. This snug fit allow the interconnect 12 to be freely slidably movable in a vertical direction when positioned in the aperture 34 while preventing cocking therein. The aperture 34 preferably is open at opposite ends 36 thereof. The interconnect 12 is dimensioned so that its length is slightly longer than the vertical length of the aperture 34. This dimensioning in combination with the openings 38 allows the interconnect 12 to protrude from the aperture 34. This allows the interconnect 12 to be in electrical contact with the traces 20 and 22 of the card 16 and motherboard 18 when they are attached to the housing 14 thereby performing its desired function of electrically interconnecting the electrical conductors 20 and 22 of the card 16 and motherboard 18.

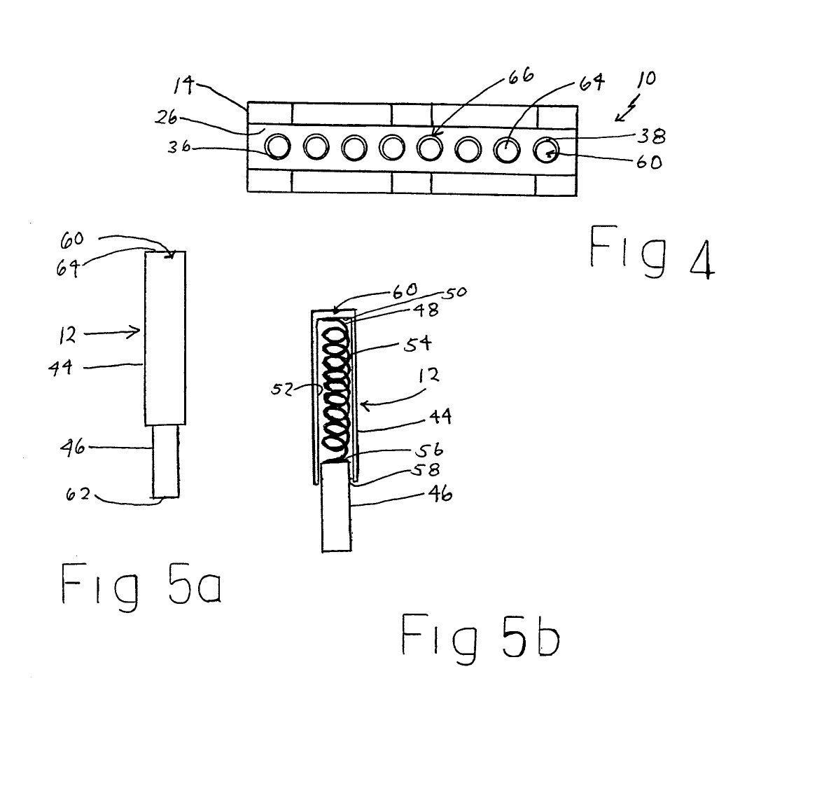

As shown in detail in FIGS. 5a and 5b, the interconnect 12 includes an interconnect main body or shaft 44 and a pin 46. Both the shaft 44 and the pin 46 are preferably cylindrically shaped. The interconnect main body has inner end wall 50 and inner lateral walls 52 which define a bore 48 which receives the pin 46. The bore 48 is preferably circular in cross-section. The pin 46 is preferably slidably mounted in the bore 48 so that it can move in the bore 48 and along the lateral walls 52 in the longitudinal direction of the main body 44 i.e., the pin 46 is able to move axially from and into the bore 48. The bore 48 and the pin 46 are preferably laterally dimensioned so that there is a snug fit between the bore 48 and the pin 46. This snug fit allows the pin 46 to be freely slidably movable in a vertical direction when positioned in the bore 48 while preventing cocking of the pin 46 in the bore 48. The pin 46 is also preferably biased relative to the main body 44 by means of a spring 54 mounted within the bore 48 and positioned between the end wall 50 and an inner face 56 of the pin 46. The spring 54 exerts a force on the pin 46 and main body 44 which tends to separate the end wall 50 and face 56 thereby acting to extend the pin 46 from the open end 58 of the bore 48 so that it protrudes therefrom. Thus, the biasing of the pin 46 makes it move outwardly from the aperture 32 until it is fully extended or until it comes into physical contact with the desired trace 20 or 22 so that it essentially functions as a plunger. Thus, it is specifically the pin 46, as a component part of the interconnect 12, which comes into direct and physical contact with the desired trace 20 or 22.

The interconnect 12 is preferably oriented so that the pin 46 comes into contact with the trace 20 of the card 16 while the base 48 comes into contact with the trace 22 of the motherboard 18, as shown in FIG. 2. More specifically, however, the interconnect pin 46 comes directly into contact with the circuit termini 40 of the card 16, and the base 60 comes directly into contact with the circuit termini 42 of the motherboard 18.

The interconnect 12 is composed of an electrically conducting material so that it can allow the transmission of an electrical current therethrough and thereby also enable transmission of an electrical current between the card 16 and motherboard 18. Preferably, the spring 54 is also composed of an electrically conducting material and is electrically connected, preferably at ends thereof, to the pin 46 and the interconnect main body 44 to allow transmission of an electrical current between the pin 46 and main body 44. Specifically, at least the base 60 of the main body 44 and at least the outer face 62 of the pin 46 are composed of an electrically conducting material since these are the component portions that come into direct physical contact with the traces 20 and 22 and thereby form the desired electrical interconnection. The outer surface 64 of the base 60 and the outer face 62 are flat. Preferably, for simplicity of construction, the entire main body 44 and pin 46 are composed of an electrically conducting material. But rather than rely on the sliding physical contact therebetween for electrical interconnection which would be likely to produce arcing, the spring connection between the pin 46 and the main body 44 preferably provides the desired electrical connection.

The housing 14 is preferably composed of an insulating material. This dielectric construction of the housing 14 prevents any undesired electrical current transmission between the interconnect 12 and housing 14 which might otherwise result in undesired electrical transmission to other traces of the components or other parts of the components.

As shown in FIG. 4, the aperture 34 is preferably a plurality of apertures 34. The apertures 34 are preferably configured so that they form a single row 66. However, configurations other than a single row 66 may also be utilized, if desired.

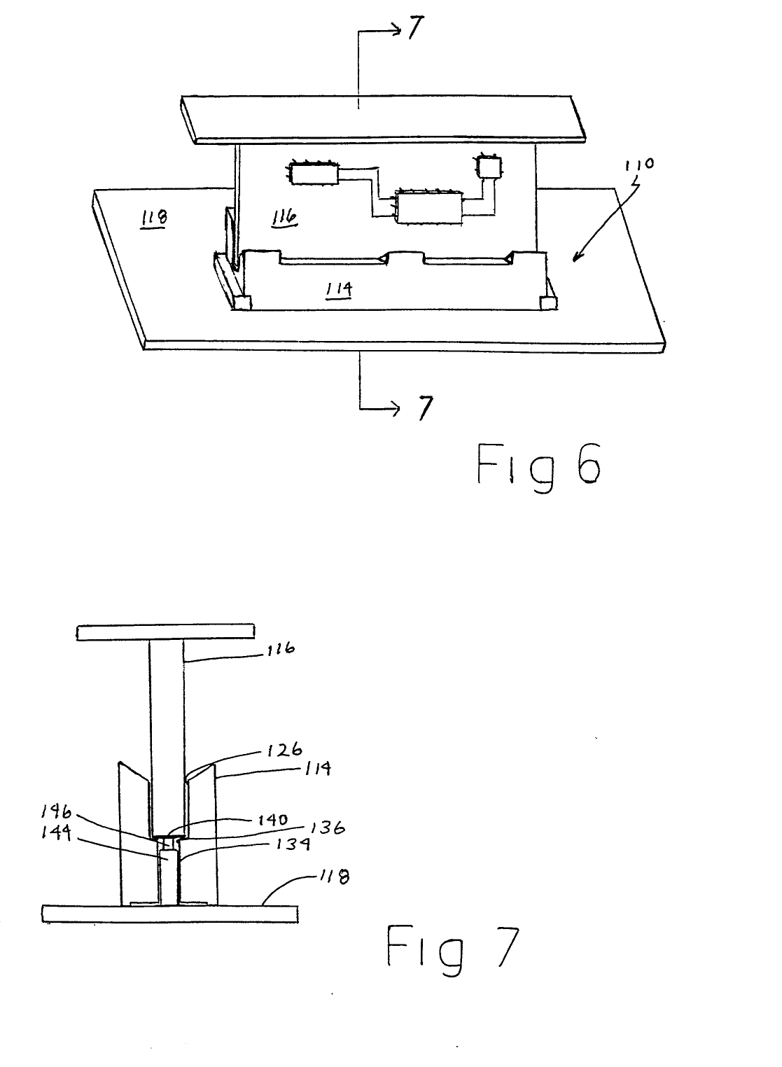

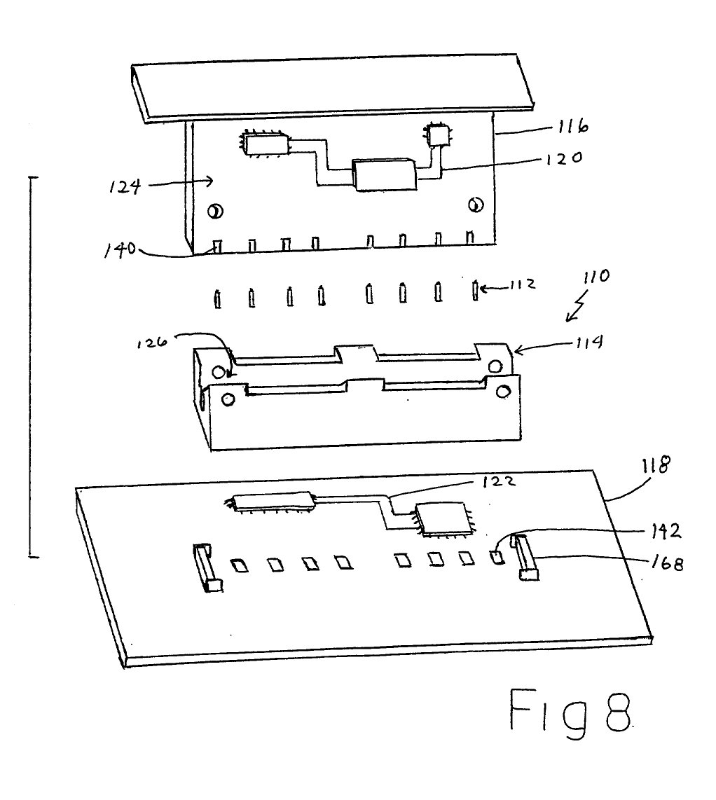

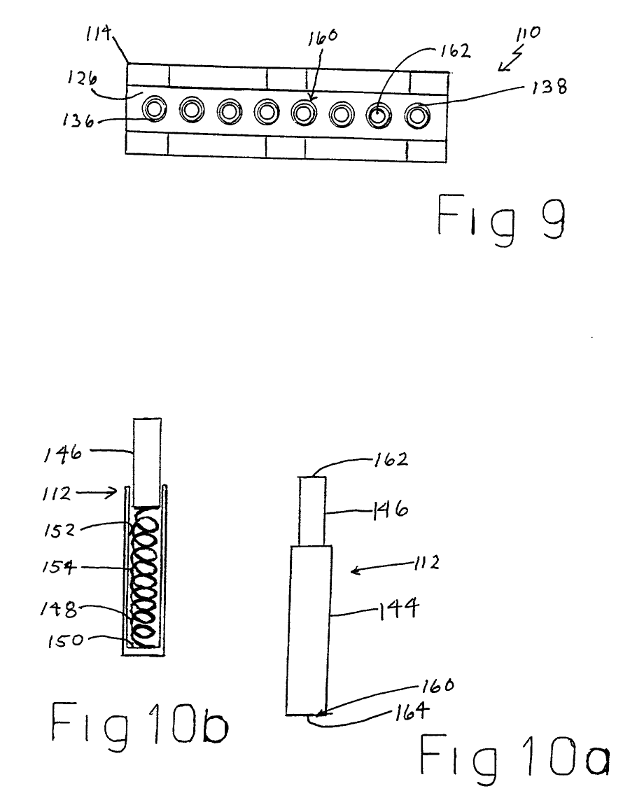

FIGS. 6 through 10 depict a second embodiment of the invention generally designated by the numeral 110. Embodiment 110 is basically the same as embodiment 10 in that the assembly 110 includes an interconnect 112 and a housing 114 having a circular aperture 134 (preferably a row 166 of apertures 132) for receiving the interconnect 112 therein. As with embodiment 10, assembly 110 is also used for interconnecting a pair of circuit boards which are of conventional design in that they have conductive paths 120 and 122 cladded to the substrate 124 and may have various electronic components (not shwon) connected with the conductive paths 120 and 122. As with embodiment 10, the aperture has open ends 136 and the interconnect 112 is longer than the aperture 134 so that the interconnect protrudes from the aperture 134.

The interconnect 112 also has a main body 144 with a bore 148 which receives a pin 146 therein. The pin 146 slides in the bore 148 along the inner lateral walls 152 of the interconnect 112. A biasing means preferably in the form of a spring 154 is physically connected to the inner end wall 150 of the interconnect 112 and the inner face 56 of the pin 146 for electrically connecting the pin 146 and main body 144 together. The interconnect 112 is preferably composed of an electrically conducting material whereas the housing 114 is preferably composed of a dielectric material to prevent undesired electrical interconnection therebetween. The pin 146 is preferably rod shaped i.e., circular in cross-section, and the main body 144 is preferably cylindrical i.e., circular in cross-section.

The interconnect 112 also has at its pin 146 portion an outer face 162 which is flat. The interconnect 112 also has at its base 160 portion an outer surface 164 which is flat.

The housing 114 is preferably attached to a motherboard 118. The housing 114 preferably has a recess 126 for receiving a computer card 116 therein and enabling the card 116 to be attached to the housing 114.

The embodiment 110 is different from embodiment 10 in that whereas assembly 10 uses a guide 28 for insertion in the guide hole 30 of guide block 32 attached to the housing 14 assembly 110 uses a guide bracket 168 mounted on the motherboard 118 for positioning the assembly 110 on the motherboard. Thus, in embodiment 110, assembly is detachably mounted on the motherboard 118 and fixedly attached to the daughterboard 116. In addition, the interconnect 112 is in an inverted position such that the pin 146 thereof contacts the traces 120 and, more specifically, the circuit termini 140 of the daughterboard 116 and the base 160 contacts the traces 122 and, more specifically, the circuit termini 142 of the motherboard. In contrast, the interconnect pin 46 of embodiment 10 contacts traces 22 (termini 42) of the motherboard and the base 60 contacts traces 20 (termini 40) when the assembly 10 is attached to the boards 16 and 18.

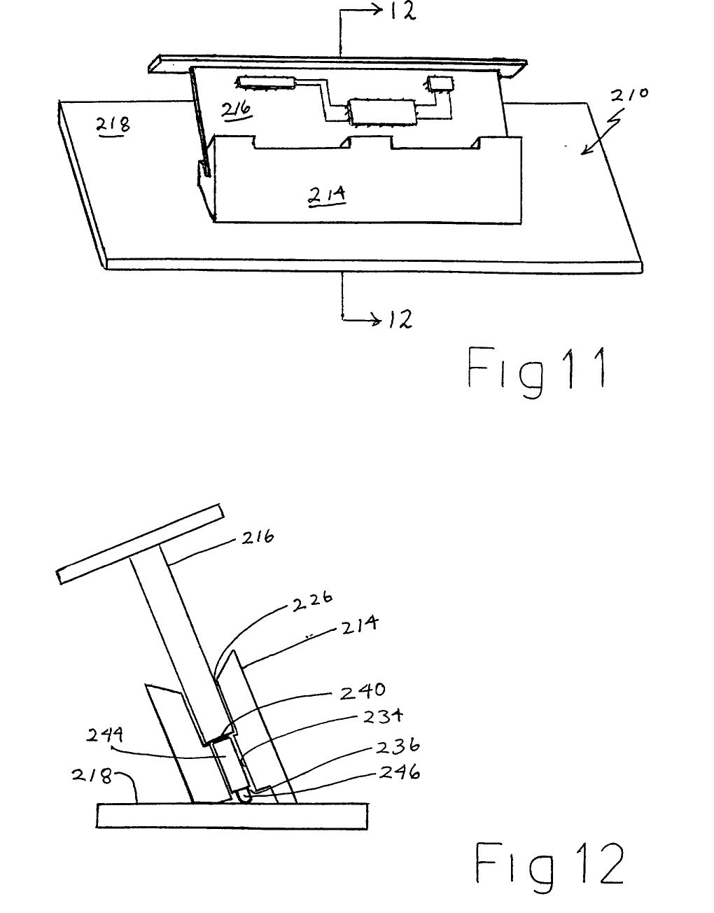

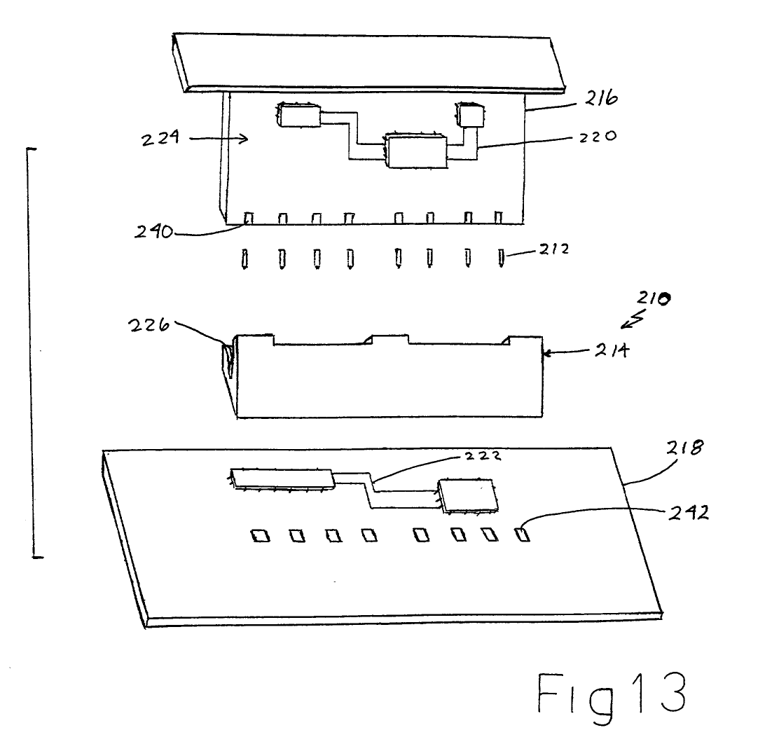

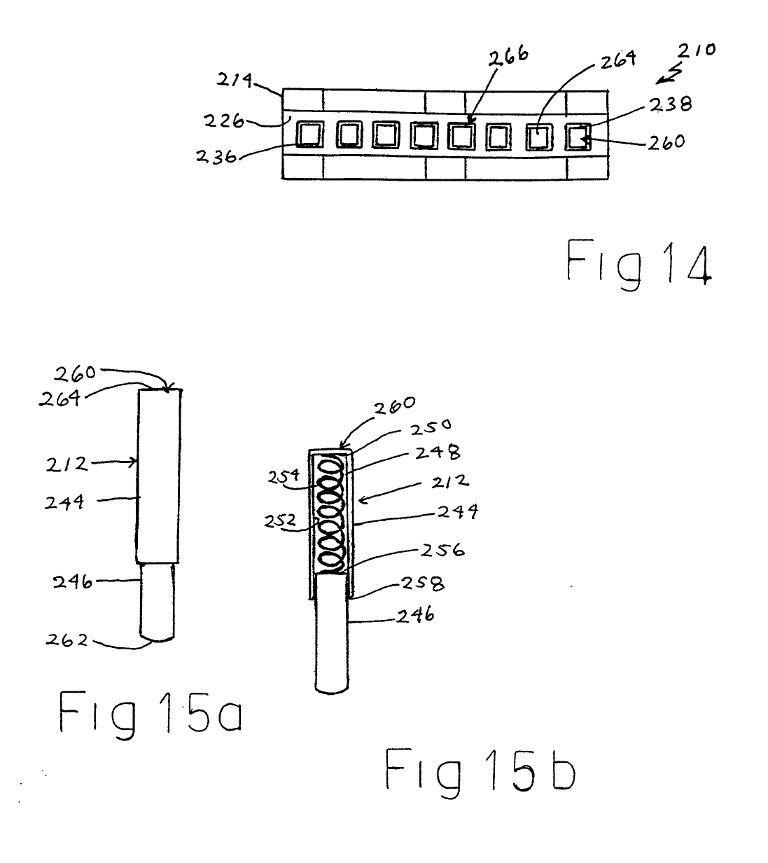

FIGS. 11 through 15 depict a third embodiment of the invention generally designated by the numeral 210. Embodiment 210 is basically the same as embodiments 10 and 110 in that the assembly 210 includes an interconnect 212 and a housing 214 having a circular aperture 234 (preferably a row 266 of apertures 234) for receiving the interconnect 212 therein. In addition, the aperture has open ends 236 and the interconnect 212 is longer than the aperture 234 so that the interconnect protrudes from the aperture 234, as with embodiments 10 and 110.

The interconnect 212 also has a main body 244 with a bore 248 which receives a pin 246 therein. The pin 246 slides in the bore 248 along the inner lateral walls 252 of the interconnect 212. A biasing means preferably in the form of a spring 254 is physically connected to the inner end wall 250 of the interconnect 212 and the inner face 256 of the pin 246 for electrically connecting the pin 246 and main body 244 together. The interconnect 212 is preferably composed of an electrically conducting material whereas the housing 214 is preferably composed of a dielectric material to prevent undesired electrical interconnection therebetween (specifically between lateral outer walls of the interconnect 212 and the housing 214). The pin 246 is preferably rod shaped i.e., circular in cross-section, and the main body 244 is preferably cylindrical i.e., circular in cross-section.

The housing 214 is preferably fixedly attached to a motherboard 218. But, the housing 214 preferably has a recess 226 for receiving a computer card 216 therein and enabling the card 216 to be detachably attached to the housing 214.

The embodiment 210 is different from embodiments 10 and 110 in that whereas assembly 10 is structured so that the card 16 is oriented so that it is perpendicular to the motherboard 18 when they are mounted on or against the housing 14 assembly 210 is structured so that the card 216 is oriented so that it forms an acute angle with the motherboard 218 when they are mounted on or against the housing 214. The embodiment 210 is also different from embodiments 10 and 110 in the shapes of the outer face 262 of the pin 246 and the outer surface 264 of the base 260. The shape of the outer face 262 and the shape of the outer surface 264 are outwardly curved and more specifically convex. In contrast, the shapes of the outer face 62 (and 162) of the pin 46 (and 146) and outer surface 64 (and 164) of the base 60 (and 160) are flat. The convex shape enables a firm and positive electrical connection to be made even when the card 216 and motherboard 218 are not in exact alignment. In addition, the convex shape enables a firm and positive electrical connection to be made even when the traces 220 and 222 or, more specifically, the circuit termini 240 and 242 which are to be interconnected are not parallel to each other or in another manner not matched up for optimal interconnection.

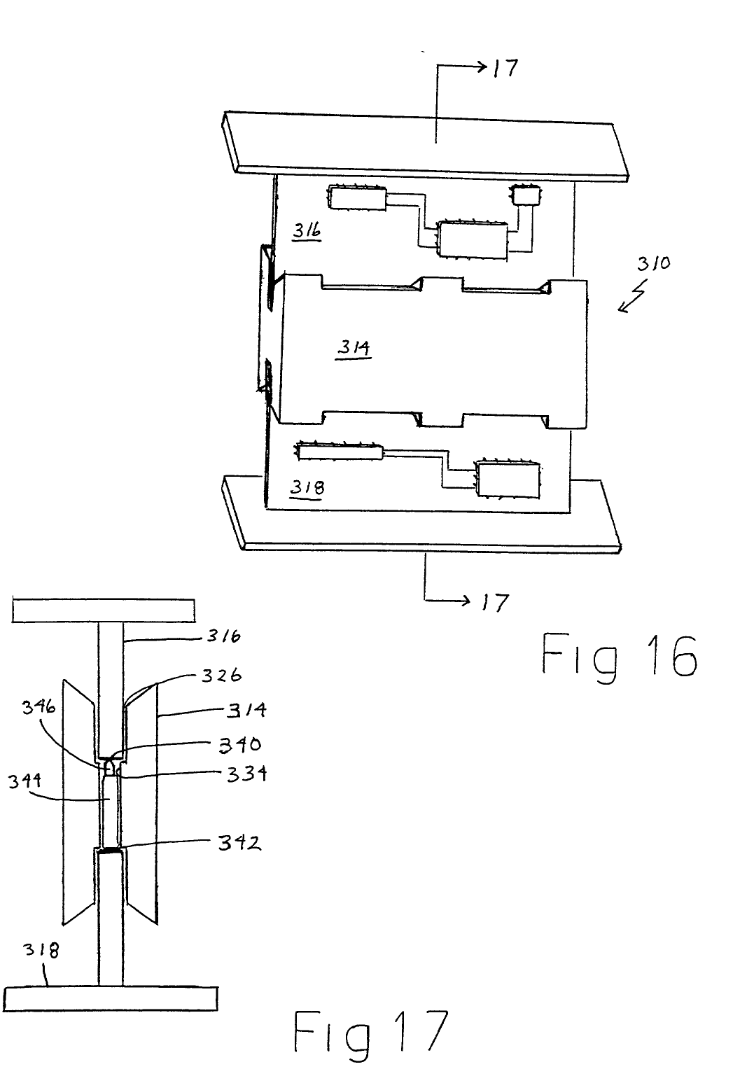

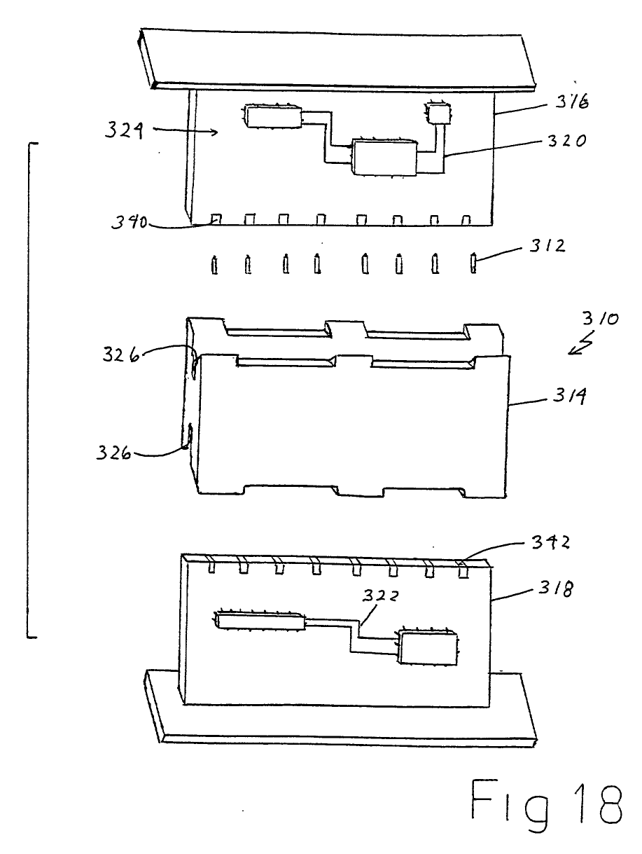

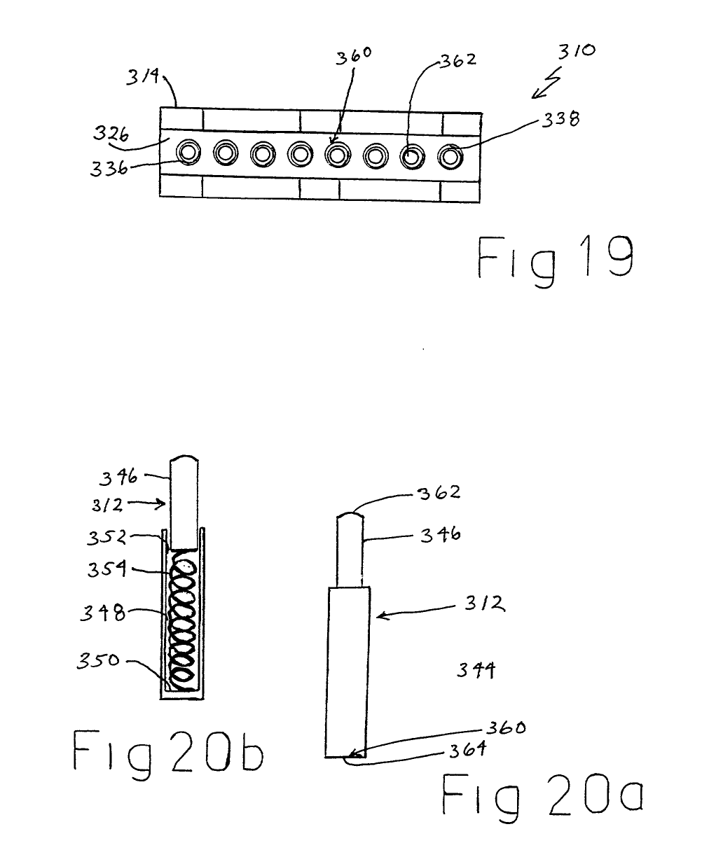

FIGS. 16 through 20 depict a fourth embodiment of the invention generally designated by the numeral 310. Embodiment 310 is basically the same as embodiments 10, 110 and 210 in that the assembly 310 includes an interconnect 312 and a housing 314 having an aperture 332 (preferably a row 366 of apertures 334) for receiving the interconnect 312 therein. In addition, the aperture 334 has open ends 336 and the interconnect 312 is longer than the aperture 334 so that the interconnect protrudes from the aperture 334, as in embodiments 10, 110 amd 210.

The interconnect 312 also has a main body 344 with a bore 348 which receives a pin 346 therein. The pin 346 slides in the bore 348 along the inner lateral walls 352 of the interconnect 312. A biasing means preferably in the form of a spring 354 is physically connected to the inner end wall 350 of the interconnect 312 and the inner face 356 of the pin 346 for electrically connecting the pin 346 and main body 344 together. The interconnect 312 is preferably composed of an electrically conducting material whereas the housing 314 is preferably composed of a dielectric material to prevent undesired electrical interconnection therebetween. The pin 346 is preferably block or box shaped i.e., square in cross-section, and the main body 344 is preferably square in cross-section.

The housing 314 is preferably fixedly attached to a motherboard 318. But, the housing 314 preferably has a recess 326 for receiving a computer card 316 therein and enabling the card 316 to be detachably attached to the housing 314.

The embodiment 310 is different from embodiments 10, 110 and 210 in that whereas assembly 10 (and 110) is structured so that the card 16 (and 116) is oriented so that it is perpendicular to the motherboard 18 (and 118) when they are mounted on or against the housing 14 (and 114) and assembly 210 is structured so that the card is oriented so that it is at an acute angle relate to the motherboard assembly 310 is oriented so that it in alignment with the motherboard 318 and positioned end to end with the motherboard 318 when they are mounted on or against the housing 314. The embodiment 310 is also different from embodiments 10, 110 and 210 in the shapes of the outer face 362 of the pin 346 and the outer surface 364 of the base 360. The shape of the outer face 362 and the shape of the outer surface 364 are outwardly curved and more specifically form an arc in cross-section i.e., form a longitudinal section of a cylinder. In contrast, the shapes of the outer face 62 (and 162) of the pin 46 (and 146) and outer surface 64 (and 164) of the base 60 (and 160) are flat and the shape of the outer face 162 (and 162) and the shape of the outer surface 264 are convex. The curved shape enables a firm and positive electrical connection to be made when the traces 320 and 322 or the circuit termini 340 and 342 which are to be interconnected are at an angle relative to each other. Indeed, the firm and positive electrical connection may be made when these components to be interconnected are at any acute angle relative to each other. Thus, the curved shape allows the desired electrical connection to be made within a wide range of angular orientations of the boards 316 and 318 relative to each other.

The length of the apertures 34, 134, 234 and 334 is preferably in the range of two to four and one-half millimeters and is a little longer than the length of the interconnect main body 44, 144, 244 and 344. The length of the pin 46, 146, 246 and 346 is preferably in the range of one-half to one millimeter. The travel of the pin 46, 146, 246 and 346 relative to the bore 48, 148, 248 and 348 is preferably one-eighth to one millimeter. The travel is preferably three-quarters of the length of the pin 46, 146, 246 and 346. The length of the interconnect 12, 112, 212 and 312 when it is fully compressed i.e., when at it minimal total length is in the range of two and one-eighth to four and five-eighths millimeters or slightly more than the length of the apertures 34, 134, 234 and 334.

Accordingly, there has been provided, in accordance with the invention, an assembly which provides a firm and positive electrical interconnection between electrical conductors within a wide range of relative orientations of the conductors which are interconnected and thus fully satisfies the objectives set forth above. It is to be understood that all terms used herein are descriptive rather than limiting. Although the invention has been specifically described with regard to the specific embodiments set forth herein, many alternative embodiments, modifications and variations will be apparent to those skilled in the art in light of the disclosure set forth herein. Accordingly, it is intended to include all such alternatives, embodiments, modifications and variations that fall within the spirit and scope of the invention as set forth in the claims hereinbelow.

What is claimed is:

1. An assembly for interconnecting electrical conductors, comprising:
an interconnect main body having a bore therein, said bore being open at an end portion thereof;
a pin positioned in the bore and movable in the bore;
means for electrically connecting said pin to said interconnect main body;
a biasing means for biasing said pin against said interconnect main body;
a housing having an aperture for receiving said interconnect main body and said pin;
first means for attaching said housing to a first structure including an electrical conductor, said interconnect main body making electrical contact with said first electrical conductor when said housing is attached thereto;
second means for attaching said housing to a second structure including a second electrical conductor, said pin making electrical contact with said second electrical conductor when said housing is attached thereto.

2. The assembly of claim 1 wherein the aperture is open at opposite ends thereof.

3. The assembly of claim 1 wherein said pin has a travel length which is three-fourths of length of said pin.

4. The assembly of claim 1 wherein the aperture has a selected aperture length and said interconnect main body has a selected main body length which is less than the selected aperture length and when said pin is extended out to its maximal length from said interconnect main body said interconnect main body and said pin have a total maximal length and when said pin is retracted into said main body so that it extends out its minimal length from said interconnect said interconnect main body and said pin have a total minimal length so that the selected aperture length is less than the total maximal length and less than the total minimal length.

5. The assembly of claim 4 wherein the total minimal length is one-eighth of a millimeter more than the selected aperture length.

6. The assembly of claim 1 wherein the aperture is circular and said interconnect main body is circular in cross-section.

7. The assembly of claim 1 wherein the aperture is square and said interconnect main body is square in cross-section.

8. The assembly of claim 1 wherein said first means for attaching provides detachable attachment of said housing to said first structure.

9. The assembly of claim 1 further including a guide for guiding said first structure into a desired position on said housing.

10. The assembly of claim 1 wherein said biasing means includes a spring mounted within the bore and engaging said pin.

11. The assembly of claim 10 wherein said means for electrically connecting includes said spring electrically connected to said main body and to said pin.

12. The assembly of claim 1 wberein said first structure is planar and said second structure is planar and said first structure is oriented so that it is normal to said second structure when said housing is attached to said first and second structures.

13. The assembly of claim 1 wherein said first structure is planar and said second structure is planar and said first structure oriented so that it forms an acute angle with said second structure when said housing is attached to said first and second structures.

14. The assembly of claim 13 wherein said pin has a tip which is convex to enhance electrical connection between said interconnect and said first electrical conductor or said second electrical conductor and thereby facilitate orientation of said first structure relative to said second structure so that it forms the acute angle therewith.

15. The assembly of claim 13 wherein said pin has a tip which is curved to enhance electrical connection between said interconnect and said first electrical conductor or said second electrical conductor and thereby facilitate orientation of said first structure relative to said second structure so that it forms the acute angle therewith.

16. The assembly of claim 1 wherein said housing receives an end portion of said first structure of said first electrical conductor and said interconnect making electrical contact with said first electrical conductor at a first edge portion of said first structure.

17. The assembly of claim 16 wherein said end portion is an edge connector and said first structure is a circuit board and wherein said housing includes a recess for receiving said edge connector therein.

18. The assembly of claim 1 wberein said first structure is planar and said second structure is planar and said first structure is positioned so that it is edge to edge with said second structure when said housing is attached to said first and second structures and said interconnect in electrical contact with said first electrical conductor at a first edge portion of said first structure and in electrical contact with said second electrical conductor at a second edge portion of said second structure.

19. The assembly of claim 18 wherein said first structure is oriented so that it is in alignment with said second structure when said housing is attached to said first and second structures.

20. The assembly of claim 1 wherein said housing is composed of insulating material to electrically isolate lateral portions of said interconnect.
